(19) United States
(12) Patent Application Publication
(10) Pub. No.: US 2018/0349228 A1
(43) Pub. Date: Dec. 6, 2018

(54) DEVICES AND METHODS FOR RECOVERING DATA FROM COMPUTERS

(71) Applicant: BSD Research LLC, North Miami Beach, FL (US)

(72) Inventors: Daniel Goodman, North Miami Beach, FL (US); Pavels Jonkins, Marbella (ES)

(21) Appl. No.: 16/001,919

(22) Filed: Jun. 6, 2018

Related U.S. Application Data
(60) Provisional application No. 62/516,102, filed on Jun. 6, 2017.

(51) Int. Cl. G06F 11/14; G06F 9/4401; G06Q 10/08

(52) U.S. Cl. CPC G06F 11/1451; G06F 11/1456; G06Q 10/083; G06F 9/4403; G06F 11/1469

(57) ABSTRACT

A device for recovering data from a computer includes a data storage device that is capable of being coupled to a communication port of the computer. The data storage device stores a recovery program. The recovery program may automatically execute when the data storage device is coupled to the communication port of the computer and the computer is on. When executing, the recovery program may start up, or boot, a processor of the computer. The recovery program may be used on a computer with a defective operating system. Security (e.g., a password, etc.) may be automatically bypassed during execution of the recovery program. The recovery program enables a user to identify and copy files that have been stored on a hard drive associated with the old computer, and to copy selected files to another data storage device. The device may also present a user with an option to wipe the hard drive and to facilitate recycling of the old computer.

### CROSS-REFERENCE TO RELATED APPLICATION

A claim for priority to the Jun. 6, 2017 filing date of U.S. Provisional Patent Application 62/516,102, titled DEVICES AND METHODS FOR RECOVERING DATA FROM COMPUTERS (“the '102 Provisional Application”), is hereby made pursuant to 35 U.S.C. § 119(e). The entire disclosure of the '102 Provisional Application is hereby incorporated by reference.

### TECHNICAL FIELD

This disclosure relates generally to devices and methods for recovering files or other data from the hard drives of computers, including computers that no longer start up, or boot, properly, computers with defective file systems, and computers that cannot be accessed due to forgotten passwords. More specifically, this disclosure relates to the use of a device that includes a data storage device with a recovery program that will automatically execute when the data storage device is coupled to a communication port of a computer with a hard drive from which files or other data are to be recovered and when the computer is powered on, or turned on.

### BACKGROUND

Personal computers typically have a life span of about two or three years. Approximately thirty million computers become defective every year. Approximately one hundred million new computers are sold each year. Once a personal computer is replaced, it is typically stored, with files remaining on its hard drive. From time-to-time, a user may want to access files that have been stored on one or more hard drives associated with the personal computer (e.g., photo files, video files, other personal and family data, etc.). Such access may be impeded, however, by slow operating systems, defective operating systems, and forgotten and lost passwords.

Old personal computers often consume valuable storage space. When a user decides to divest himself or herself of an old personal computer, internal hard drives usually remain in the computers. So do the files that have been stored on the internal hard drives, which may present a significant security risk.

### SUMMARY

A device for recovering files or other data from the hard drive of a computer in accordance with this disclosure may be referred to as a “data recovery device.” A data recovery device of this disclosure may comprise a data storage device that is capable of being coupled to a communication port of the computer. In some embodiments, the data storage device may comprise a so-called “memory stick,” or flash drive, with a USB (universal serial bus) connector. Other embodiments of data storage devices include SD (secure digital) cards, micro SD cards, and the like.

The data storage device stores a data recovery program. The data recovery program may automatically execute when a data storage device (e.g., a dedicated data storage device on which the data recovery program is provided; a data storage device, such as a memory stick, a smartphone, a tablet computer, or the like, to which the data recovery program has been downloaded, etc.) is coupled to the communication port of the computer and the computer is turned on. Automatic execution of the data recovery program may occur by, prior to turning the computer on, plugging the data storage device into a communication port of the computer, and then turning the computer on. Alternatively, the data recovery program may be automatically executed by plugging the data storage device into a communication port of a computer that has already been turned on. As another alternative, if the data storage device is plugged into a communication port of a computer that has already been turned on, execution of the data recovery program may require user initiation.

As the data recovery program executes, it may cause the computer to start up, or boot, off of a Linux operating system. Use of a Linux operating system to start up, or boot, the computer may enable the data recovery device to boot a computer with an antiquated, or slow, operating system, a computer with a defective operating system, or an otherwise defective computer (e.g. a computer that will not boot, a computer with an operating system that will not start, etc.). Use of a Linux operating system to boot a computer may also bypass any security requirements of the computer's operating system, thereby enabling use of the data recovery device with a computer whose passwords have been forgotten.

The operating system that is used to boot the computer may cause a system script, or application, to mount each hard drive associated with the computer (e.g., each internal hard drive carried within a housing for the computer, each external hard drive that has been physically coupled to a communication port of the computer, etc.). The data recovery program may enable mounting of each hard drive even if the computer's file system (e.g., NTFS (new technology file system) in the WINDOWS® operating system, HFS Plus in the macOS operating system, etc.) is defective.

Once each hard drive associated with the computer has been mounted, the data recovery program may be capable of providing a user with a variety of options. Among these options, the data recovery program may offer a user a selection for recovering files or other data from one or more hard drives associated with the computer. If that option is selected, the data recovery program may then identify files stored by the one or more hard drives and cause a monitor associated with the computer to display each file that has been identified. The files that have been identified may be displayed in such a way that a user may select each file that is to be copied. A user interface generated by the data recovery program may also enable a user to select one or more data storage devices to which he or she would like to copy each selected file. The data recovery program may enable each selected file to be copied to memory that is independent from the computer, such as the data storage device itself, an external hard drive that has been coupled to the computer (e.g., by way of a communication port, etc.), memory that has been networked to the computer, or internet-based, or cloud-based, memory. Once the user has selected each file that he or she would like to copy, as well as one or more locations to which he or she would like to copy each file, the data recovery program may copy each selected file to the selected location(s). Files may be identified, selected, and copied without altering any of the data on the hard drive(s) associated with the computer where they reside; i.e., with respect to identifying and accessing files from each hard drive associated with the computer, the data recovery device may function as a read-only device.

As another option, the data recovery program may be capable of erasing data from, or “wiping,” one or more hard drives associated with a computer. The data recovery program may present such an option to a user when the option to identify files is provided, when providing the user with the option to select any files that are to be copied, or after copying selected files. Upon user selection of the option to wipe one or more hard drives associated with the computer, the data recovery program may wipe each selected hard drive. In addition, the data recovery program may be capable of generating a label for shipping each wiped hard drive and/or the computer with which each wiped hard drive is associated to an electronics recycling facility. The data recovery program may also be capable of generating a certificate indicating that the wiped hard drive complies with governmental requirements (e.g., data security requirements, such as wipe method US DoD 5220.22-M, which requires three passes and verification that all data has been removed from the hard drive, etc.), such as those established by the United States Environmental Protection Agency (EPA).

In another aspect, methods for recovering files from one or more hard drives associated with a computer are disclosed. Such method may include coupling a data recovery device to the computer, turning the computer on, and allowing a data recovery program stored by memory of the data recovery device to start up, or boot, the computer. An operating system stored by the data recovery device may boot the computer. One or more hard drives associated with the computer may be mounted (e.g., by an operating system of the computer, by an operating system stored by the data recovery device, etc.). Once at least one hard drive associated with the computer has been mounted, files on that hard drive may be identified, selection of the identified files may be enabled, and selected files may be copied to a hard drive independent from the computer.

Such a method for recovering files may be used with an old computer, with a computer that has an outdated operating system, a computer that will not properly boot or start, or to migrate data from one properly functioning computer to another properly functioning computer.

In some embodiments, a user may be provided with an option to prepare the computer for disposal, such as recycling. Preparation of the computer for disposal may include wiping the hard drive and facilitating recycling of the hard drive and/or of the computer of which the hard drive is a part may be facilitated.

Other aspects, as well as features and advantages of various aspects, of the disclosed subject matter will become apparent to those of ordinary skill in the art through consideration of the ensuing description, the accompanying drawings, and the appended claims.

### BRIEF DESCRIPTION OF THE DRAWINGS

In the drawings:

FIG. 1 is a schematic representation of an embodiment of a data recovery device according to this disclosure;

FIG. 1A is a schematic representation of an embodiment of a device that enables data recovery and hard drive erasure according to this disclosure;

FIG. 2 schematically depicts an embodiment of use of a data recovery device with a computer with an associated hard drive from which files or other data are to be recovered;

FIG. 3 is a flow diagram illustrating an embodiment of a data recovery process according to this disclosure; and

FIGS. 4-10 depict various pages of an embodiment of a user interface of a data recovery program according to this disclosure.

### DETAILED DESCRIPTION

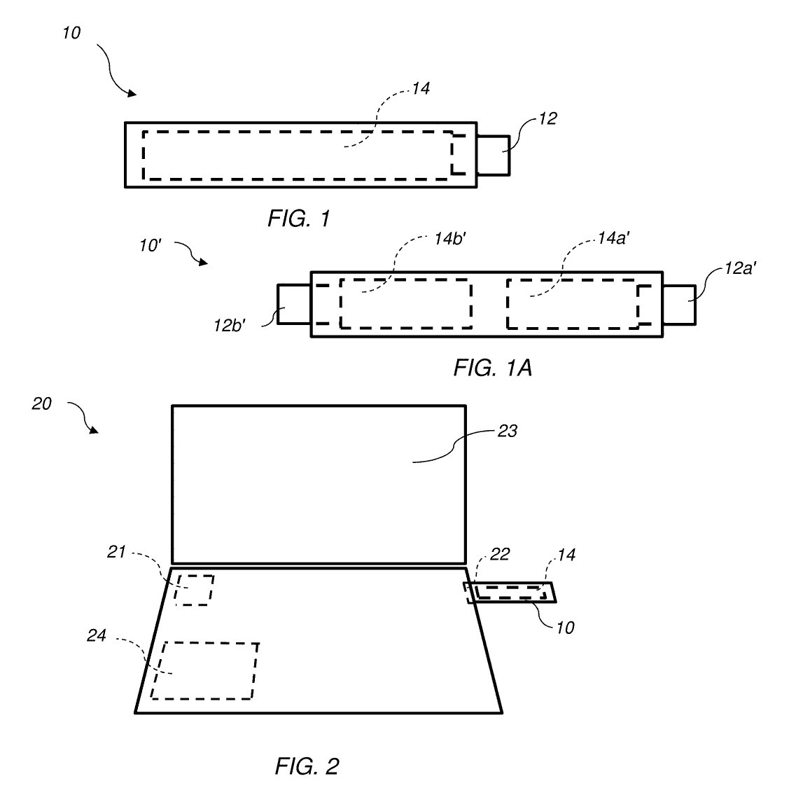

With reference to FIG. 1, an embodiment of a data recovery device 10 is illustrated. That data recovery device 10 includes a connector 12 that is capable of being coupled to a communication port of a computer. In the embodiment depicted by FIG. 1, the connector 12 comprises a USB connector, although a data recovery device 10 according to this disclosure may include any other suitable type of connector. The data recovery device 10 also includes data storage 14, such as a so-called flash memory (e.g., NAND flash, etc.). In some embodiments, the data recovery device 10 may comprise a dedicated data storage device (e.g., a memory stick, and SD card, etc.) on which the data recovery program is provided. In other embodiments, the data recovery device 10 may comprise any suitable device for storing data and to which the data recovery program may be downloaded. In some more specific embodiments, the data recovery device 10 may comprise a portable electronic device, (e.g., a smartphone, a tablet computer, etc.) to which the data recovery program may be downloaded as a so-called “mobile app.” In such an embodiment, the portable electronic device may be physically connected to a computer (e.g., by way of a communication cable that includes a USB connector, etc.).

The data storage 14 of the data recovery device 10 stores a data recovery program and, optionally, an operating system (e.g., a Linux operating system, etc.). A portion of the data storage 14 may be reserved for files that are copied from a hard drive that is to be accessed using the data recovery device 10.

More specifically, the data storage 14 of the data recovery device store a read-only filesystem, a writable application filesystem, and a writable data filesystem. In some embodiments, a single data recovery device 10 may include all of these file systems. In other embodiments, the file systems may be stored by a plurality of data recovery devices 10.

The read-only filesystem includes the operating system. The operating system may be a custom distributed version of Linux (e.g., an Ubuntu-based Linux operating system, etc.), or a “custom Linux distro.” The read-only filesystem may comprise an ext4 type filesystem. The read-only filesystem may include the data recovery program a (e.g., a binary file that cannot be updated, etc.). In addition, the read-only filesystem may contain loading scripts. The loading scripts may comprise a set of custom scripts that perform various tasks after the custom Linux distro begins operating, including, without limitation, preparation of the operating environment and loading the data recovery program.

The writable application filesystem, which may also be referred to as an “internal filesystem,” may comprise resources for the data recovery program. In some embodiments, the writable application filesystem may also include the data recovery program (e.g., a redundant copy of the data recovery program, which may comprise a binary file that can be updated, etc.). The writable application filesystem may also comprise an ext4 type filesystem.

The writable data filesystem may also be referred to as an “internal data filesystem.” The writable data filesystem may receive, or comprise a destination for, files that are copied, or “rescued,” from a hard drive associated with a computer with which the data recovery device 10 is used. The writable data filesystem may comprise an NTFS type filesystem.

FIG. 2 depicts an embodiment of a method of using the embodiment of data recovery device 10 shown in FIG. 1. The connector 12 of the data recovery device 10 is inserted into a complementary communication port 22 of a computer 20 with an associated hard drive 24 from which one or more files or other data are to be recovered. The data recovery device 10 may be used with a fully functioning, fully accessible computer 20, with a computer 20 whose password has been forgotten, or with a defective computer 20 (e.g., a computer 20 with a slow or antiquated operating system, a computer 20 that will not boot, a computer 20 with an operating system that will not start, etc.). In various embodiments, the computer 20 may comprise a personal computer (PC) running a version of the MICROSOFT® WINDOWS® operating system or another PC operating system, an APPLE® computer (e.g. an iMAC® desktop computer, a MACBOOK® laptop computer, etc.) running an APPLE® operating system, or any other personal computer.

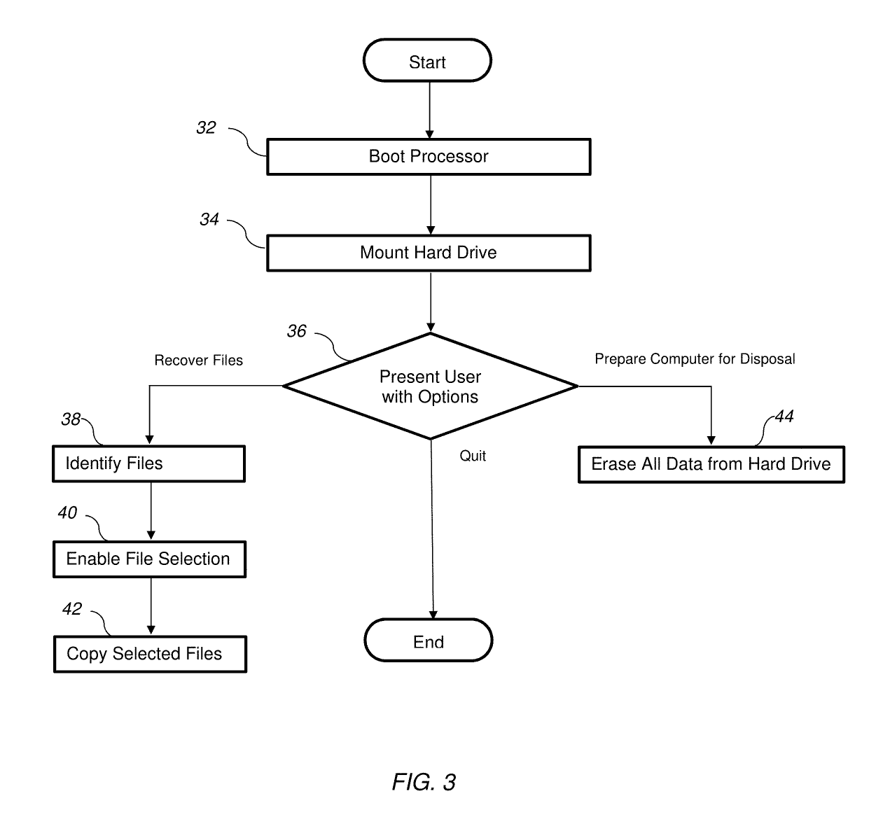

With added reference to FIG. 3, with the computer 20 turned on, an operating system may boot a processor 21 of the computer 20, at reference 32 of FIG. 3. The processor 21 may be booted by an operating system stored by the data storage 14 of the data recovery device 10. In embodiments where the data recovery device 10 comprises a portable electronic device and the data recovery program comprises a mobile app that may run on the portable electronic device, the data recovery program may enable the portable electronic device to emulate the action of an operating system. Thus, upon turning on a computer 20 to which the portable electronic device is connected, the mobile app may enable the portable electronic device to boot the computer 20 As another alternative, the processor 21 may be booted by an operating system stored by a hard drive 24 associated with the computer 20.

The operating system may mount each hard drive 24 associated with (e.g., fixed hard drives, hard drives connected to, etc.) the computer 20, at reference 34 of FIG. 3. Each hard drive 24 may contain one or more Windows® operating system filesystem(s) (e.g., NTFS, FAT).

With each hard drive 24 of the computer mounted, the data recovery program stored by the data storage 14 of the data recovery device 10 may provide a user with one or more options, at reference 36 of FIG. 3. These options may include an option to identify and select files that are to be recovered from the hard drive 24. They may also include an option to prepare the computer 20 for disposal.

If a user selects an option to recover one or more files from the hard drive 24, the data recovery program may, at reference 38 of FIG. 3, identify each file that may be recovered from the hard drive 24 and, at reference 40 of FIG. 3, enable the user to select and copy one or more of the files that have been identified to data storage that is independent from the computer 20. Additionally, the data recovery program may enable the user to select the data storage device to which each selected file is to be copied. Next, at reference 42 of FIG. 3, the data recovery program may copy each selected file to the independent data storage device.

A user may also select an option to prepare the computer 20 for disposal, such as recycling. In some embodiments, this option may be selected by way of a separate device (e.g., a separate data storage device, etc.), including by way of a device 10′ such as that depicted by FIG. 1A, which includes a data recovery element 14a′ and a data wiping element 14b′ that are coupled to one another. Such a device 10′ may include two separate connectors 12a′ and 12b′ (e.g., USB connectors, etc.). A first USB connector 12a′—that of the data recovery element 14a′—may be connected to a communication port 22 (FIG. 2) of the computer 20 (FIG. 2) to enable the recovery of data from the computer 20. Once the data recovery process is complete, the second USB connector 12b′ of such a two-sided device 10′ may be connected to a communication port 22 of the computer 20 to enable loading and execution of a program of the data wiping element 14b′ that can wipe the hard drive 24.

If the user selects the option to prepare the computer 20 for disposal, at reference 44 of FIG. 3, the data recovery program erases all data from the hard drive 24, or wipes the hard drive 24. Wiping the hard drive 24 may include deleting all files from the hard drive 24 once or a plurality of times. Wiping the hard drive 24 may further include re-initializing the hard drive 24 or another process that will permanently remove any sensitive data from the hard drive 24.

Once the hard drive 42 has been wiped, the data recovery program may provide the user with a label for shipping the hard drive 24 and/or the computer 20 with which the hard drive 24 is associated to a disposal facility (e.g., an electronics recycling facility, etc.). The data recovery program may also provide the user with a certificate that the hard drive 24 complies with any applicable governmental data security standards. In a specific embodiment, the data recovery program may generate a log file specifying the technical details of the drive wipe procedure (e.g., wipe method: US DoD 5220.22-M, which requires three passes and verification that no data remains on the hard drive 24, etc.).

The data recovery device may be used once or a plurality of times to recover data from one or more computers.

With returned reference to FIG. 1, the data recovery device 10 may store groups of files that enable one or more files or groups of The following is a list of the components of a specific embodiment of a data recovery device and/or system according to this disclosure.

Various processes of a specific embodiment of a data recovery method follow. These processes may be executed by a specific embodiment of a data recovery program and carried out by a specific embodiment of a data recovery device according to this disclosure.

As a specific, but nonlimiting example of data recovery according to this disclosure, one or more data recovery devices 10 according to this disclosure are coupled to a communication port 22 of a computer 20 before the computer 20 is turned on (e.g., by coupling a connector 12 of the data recovery device 10 to a communications port of the computer 20, etc.). The computer may then be turned on, or powered up. As the computer 20 powers up, the computer's BIOS (basic input/output system) detects the presence of the data recovery device 10 and loads the custom Linux distro.

Once loading of the custom Linux distro is complete, execution is passed to the loading scripts. The loading scripts perform a variety of functions. The loading scripts check each data recovery device 10 that has been coupled to the computer 20 by way of a communication port 22 for the presence of the internal filesystem. If the internal filesystem is present, then a check and repair procedure (e.g., an ext4 filesystem check and repair procedure, etc.) may be executed. The internal filesystem may be mounted to a folder (e.g., to a folder named “/suba,” etc.), either without a check and repair procedure or if no filesystem errors are detected during the check and repair procedure.

The loading scripts also check each data recover device 10 for the presence of the internal data filesystem. If the internal data filesystem is present, then a check and repair procedure may be executed. The internal data filesystem may be mounted to a folder (e.g., to a folder named “/media/PC-RESCUE,” etc.), either without a check and repair procedure or if no filesystem errors are detected during the check and repair procedure.

The loading scripts also access the data recovery program of the read-only filesystem on the data recovery device(s) 10. Upon locating that data recovery program, the loading scripts may identify it as the “current version.” In addition, the loading scripts may check for the presence of the data recovery program in the internal filesystem of the data recovery device(s) 10. If the data recovery program is present in the internal filesystem, the loading scripts may determine its version. If the data recovery program in the internal filesystem is more recent, or has a higher version number, than the data recovery program in the read-only filesystem, then the data recovery program in the read-only file system is re-identified as a “previous version” and the data recovery program in the internal filesystem is identified as the “current version.” The “current version” of the data recovery program may be checked to ensure that it has not been corrupted and that it is executable.

If the “current version” of the data recovery program is executable, the loading scripts may then execute it. If the “current version” is corrupt, otherwise not executable, or fails to execute properly, the loading scripts may attempt to execute a “previous version” of the data recovery program.

As the processor 21 of the computer 20 begins executing, or running, the data recovery program, the loading scripts may also load a monitoring program, which executes, or runs, concurrently with the data recovery program. The monitoring program may continuously or periodically evaluate the progress of the data recovery program and/or the operation of the computer 20 and, in some embodiments, prevent failures (e.g., software failures, hardware failures, etc.) from affecting the data recovery program. In the event that the data recovery program stops responding, the monitoring program may display a message that instructs a user to try to restart the data recovery program or to try to restart the computer 20.

Initially, in a preparation phase of execution, the data recovery program may prepare the data recovery device 10 to receive data that may be recovered from one or more hard drives 24 coupled to the computer 10 (e.g., as an internal hard drive, by way of a communication port 22, etc.). As the data recovery program begins running, it checks to determine whether the internal filesystem is mounted to the appropriate folder (e.g., to the “/suba” folder, etc.) and whether resources files are present in that folder. If the internal filesystem has not mounted or the resources files are not present in the appropriate folder, then the data recovery program causes all resources files to be loaded from a folder located on the data recovery device 10. Multiple theme description files may also be loaded. The configuration file may be loaded and parsed.

In addition, the data recovery program checks to determine whether the internal data filesystem is mounted to the appropriate folder (e.g., the “/media/PC-RESCUE” folder, etc.). If the appropriate folder is located, it is marked as the default destination for files that are rescued from a hard drive 24 associated with the computer 20 to which the data recovery device 10 has been coupled by way of a communication port 22.

Once the data recovery program has confirmed that the internal filesystem and the internal data filesystem are in place, it may cause each hard drive 24 that has been connected to the computer 20 to be scanned for one or more valid on-disk filesystems (e.g., a valid Windows® operating system filesystem, etc.). Each valid filesystem found on a hard drive 24 may be mounted to an appropriate folder (e.g., a “/media/{filesystem label}” folder, etc.). The on-disk filesystem is one of two separate trees that represents the hierarchy of files and folders found on each hard drive 24.

The data recovery program may also scan one or more operating system folders (e.g., a Windows® folder, etc.) for directories that could contain user files, which directories may be referred to herein as “user profile directories.” Each user profile directory located during such a scan may also be added to the appropriate folder.

In addition, execution of the data recovery program may include a validation phase, or an authentication phase, in which the data recovery program may cause a validation or authentication process to be executed. As part of validation, the data recovery program determines whether a local database file was previously generated on the internal filesystem of the data recovery device 10. If not, the data recovery program generates a local database file. If a local database file was previously generated, the data recovery program determines, by a process which will be described in further detail hereinafter, whether the local database file includes validation string that corresponds to the computer 20 with which the data recovery device 10 is being used.

In the event that the data recovery program does not locate a local database file on the internal filesystem or a local database file on the internal filesystem does not include a validation string that corresponds to the computer 20 with which the data recovery device 10 is being used (i.e., the data recovery device 10 has not been used with that particular computer 20), the data recovery program may generate one or more unique identifiers that correspond to the computer 20.

As part of the validation process, hardware identifiers may be read. In some embodiments, the data recovery program may send a request to a kernel module (e.g., a custom kernel module, etc.). The kernel module may read and collect available hardware identifiers, create a string, and then encrypt the string using a kernel internal encryption application programming interface (API) with a locally stored key. The encrypted string may be referred to as a “PCID string.” The PCID string may be unique to the computer 20, and may be repeatably created and encypted by the kernel module.

In addition, the validation process may include reading of a serial number, which may also comprise a unique string, to identify a specific copy of the data recovery program being executed. The serial number that corresponds to the data recovery program may have been written to a file located on the read-only filesystem.

In addition, if an internet connection is available and the computer 20 is able to connect to the internet, the data recovery program may cause the computer 20 to access a secure license management server (e.g., a MySQL database, etc.) accessible through the internet. The serial number may be used to identify a user account with which the data recovery device 20 is associated.

If the serial number does not correspond to an existing user account, the data recovery program may display a user interface prompt the user to register the data recovery device 20. The user may be required to enter identifying information (e.g., First Name, Surname, email, username (optional), serial number (which may be automatically filled based on using the serial number from the read-only filesystem. The user may then submit the information to the secure license management server. The secure license management server may then generate and send a password to the user's email address. The user may use the email address or username and the password to access his or her account page in the event that the data recovery device 10 is used with a computer 20 that cannot access the internet.

If the serial number corresponds to an existing, valid user account, a hypertext preprocessor (PHP) scripts may be executed by the secure license management server to determine whether or not use of the data recovery device 10 has exceeded a license limit (e.g., use of the data recovery device 10 on a predetermined number of different computers (e.g., one computer, two computers, three computers, etc.)). Such a determination may be made by evaluating the number of PCID strings that have already been saved to the user account. If use of the data recovery device 10 has reached the license limit, its further use will be prohibited. If use of the data recovery device 10 is within the license limit, the PHP script may accept the PCID string and save it to the user account on the secure license management server.

As the secure license management server receives the PCID string and the serial number and, optionally, a request that a validation string be generated, the PHP scripts may use a license algorithm, which may include a cryptographic key, to generate a validation string from the PCID string and the serial number. Thus, the validation string corresponds to the specific copy of the data recovery program in use and to the computer 20 with which the data recovery device 10 is being used. The validation string may be saved to the database on the secure license management server and to a local database file of the internal filesystem of the data recovery device 10.

In the event that an internet connection is not available to the computer 20 or the computer 20 cannot connect to the internet, the data recovery program may present a dialog box (e.g., a product registration box, an “Add New Computer” box, etc.). The dialog box may display a URL for the secure license management server, as well as the serial number for the data recovery program on the data recovery device 10, the PCID string, and/or instructions for registering the data recovery program and/or for adding a device to an existing user account. The user may then use another device that can access the internet (e.g., another computer, a smartphone, etc.). The user may select an option to register (e.g., as described previously herein, etc.) and create a new user account, which requires that the user enter a serial number that is not associated with an existing user account. Registration may then proceed as described previously herein.

Alternatively, the user may select an option to login to an existing user account. Since the serial number is already associated with the existing account, the user may only be required to enter PCID string information displayed by the computer 20 into a user interface. Once the PCID information is submitted, the secure license management server may execute the PHP scripts, which may determine whether or not use of the data recovery device 10 has exceeded a license limit. If use of the data recovery device 10 has reached the license limit, its further use will be prohibited. If use of the data recovery device 10 is within the license limit, the PHP scripts may accept the PCID string and save it to the user account on the secure license management server.

As the secure license management server receives the PCID string, it may access the serial number associated with the user account and use the license algorithm to generate a validation string from the PCID string and the serial number. Thus, the validation string corresponds to the specific copy of the data recovery program in use and to the computer 20 with which the data recovery device 10 is being used. The validation string may be displayed by the device that has been used to access the internet, and may be input into the dialog box displayed by the computer 20 with which the data recovery device 10 is being used. The data recovery program then saves the validation string in the local database file of the internal filesystem of the data recovery device 10.

When the data recovery program saves the validation string to the local database file of the internal filesystem, a rescue folder may be generated and named. The rescue folder may be reused, or added to, if the data recovery device 10 is used with a particular computer 20 more than once.

In addition, the data recovery program may use the license algorithm (e.g., the same algorithm as that used by the PHP scripts of the secure license management server, etc.) to generate a comparison validation string from the PCID string and the serial number. The data recovery program may then compare the comparison validation string to the validation string stored by the local database file to determine whether the comparison validation string and the stored validation string match. If the comparison validation string and the stored validation string match, the data recovery program may continue to execute, or run.

Upon successful completion of the validation or authentication process, the data recovery program may cause the processor 21 to cause a monitor 23 of or associated with the computer 20 to display a data recovery user interface (UI). The UI that is displayed may depend on a configuration setting, which may be set when during an initial setup, or registration of the data recovery device 10. In some embodiments, the UI may comprise a so-called “wizard UI,” which may include a plurality of “pages” that provide a user with step-by-step guidance for use of the data recovery program. In other embodiments, a so-called “main UI” can be displayed.

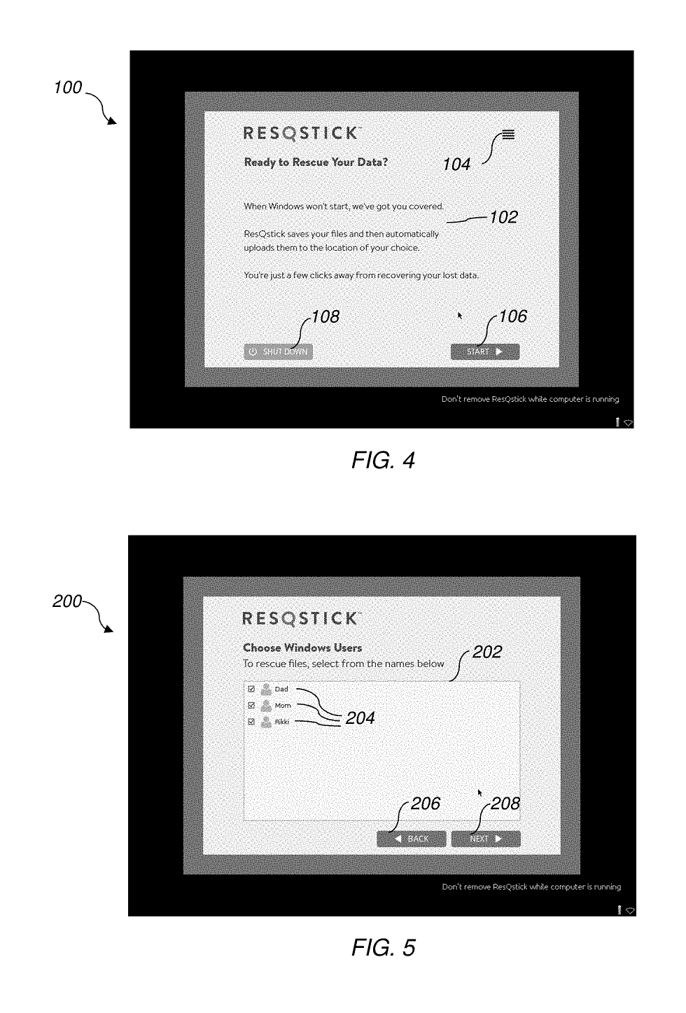

An embodiment of a wizard UI of the data recovery program is depicted with reference to FIGS. 4-10.

FIG. 4 shows a first page 100 of a wizard UI. The first page 100 may include introductory text 102, a menu 104 that enables a user to select one or more other options (e.g., to setup the data recovery program and/or the data recovery device 10 (FIGS. 1 and 2), to hide the wizard UI next time, etc.), a “Next” “button” 106, and a “Shut Down” button 108.

If the data recovery program identified at least one user profile directory during the preparation phase, a second page 200 of the wizard UI, such as that depicted by FIG. 5, may be displayed. The second page 200 of the wizard UI may show a list 202 of user profiles 204 that have been detected by the data recovery program and from which a user can select. The second page 200 of the wizard UI may also include a “Back” button 206 and a “Next” button 208.

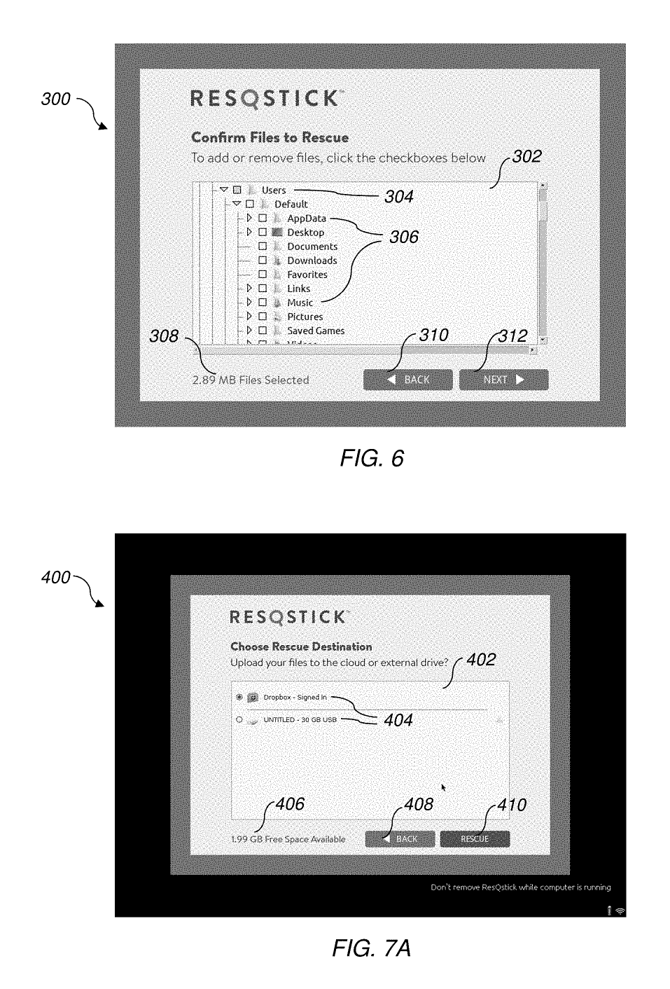

A third page 300 of the wizard UI displays a source directory tree 302, as shown in FIG. 6. The source directory tree 302 is a second of two trees that represent the hierarchy of files and folder found on a hard drive 24 (FIG. 2); the other being the previously mentioned one-disk file system. In addition to displaying the source directory tree 302, the third page of the wizard UI may display a “Back” button and a “Next” button.

If a particular user profile directory 204 (FIG. 5) was selected from the second page 200 (FIG. 5) of the wizard UI, that user profile directory 304 may be pre-selected in a display of the source directory tree 302 by the third page 300 of the wizard UI. The source directory tree 302 may enable a user to select a folder 306, deselect a previously selected folder 306, expand a folder 306, collapse a previously expanded folder 306, select one or more files, and/or deselect one or more previously selected files. The source directory tree 302 may also display additional folders and/or files (e.g., folders and/or files from another user profile directory 304, etc.).

Upon selecting a file from the source directory tree, a size of the file may be added to a total size of all selected files. The total size value 308 may be displayed by the third page 300 of the wizard UI. The total size value 308 may be used to determine whether the internal data filesystem has sufficient capacity to receive all of the selected files. When a file in the source directory tree 302 is deselected, the total size value 308 decreases by the size of the deselected file.

When a folder 306 in the source directory tree 302 is expanded, the child items (e.g., subfolders, files, etc.) of that folder may be displayed as part of the source directory tree. Items (e.g., further subfolders, files, etc.) in unexpanded subfolders may not be displayed by the source directory tree 302. Subsequently collapsing a folder may not undo any selections that have been made of items in the now undisplayed portion of the source directory tree 302.

When an expanded folder 306 is selected from the source directory tree 302, all child items (e.g., subfolders, files, etc.) in that folder 306 may be automatically selected. The cumulative sizes of all of the files in that folder 306 may be added to the total size value 308 of all selected files. In the event that the expanded folder 306 is subsequently deselected, all child items in that folder 306 may be automatically deselected and their cumulative sizes may be subtracted from the total size value 308 of all selected files.

When a collapsed folder 306 is selected, it may be flagged to indicate that if the folder 306 is expanded, all of its child items will also be shown as having been selected. This may minimize memory usage by not loading filesystem items that do not need to be displayed in memory. The sub-directory tree for the collapsed folder 306 may be recursively traversed, a sum of the sizes of all files within the collapsed folder 306 and any of its subfolders may be determined. The value of that sum may be added to the total size value 308 of all selected files. If a collapsed folder 306 is deselected, the flag may be removed and the sum of the sizes of all of the files within the collapsed folder may be subtracted from the total size value 308 of all selected files.

The third page 300 may also include a “Back” button 310 and a “Next” button 312.

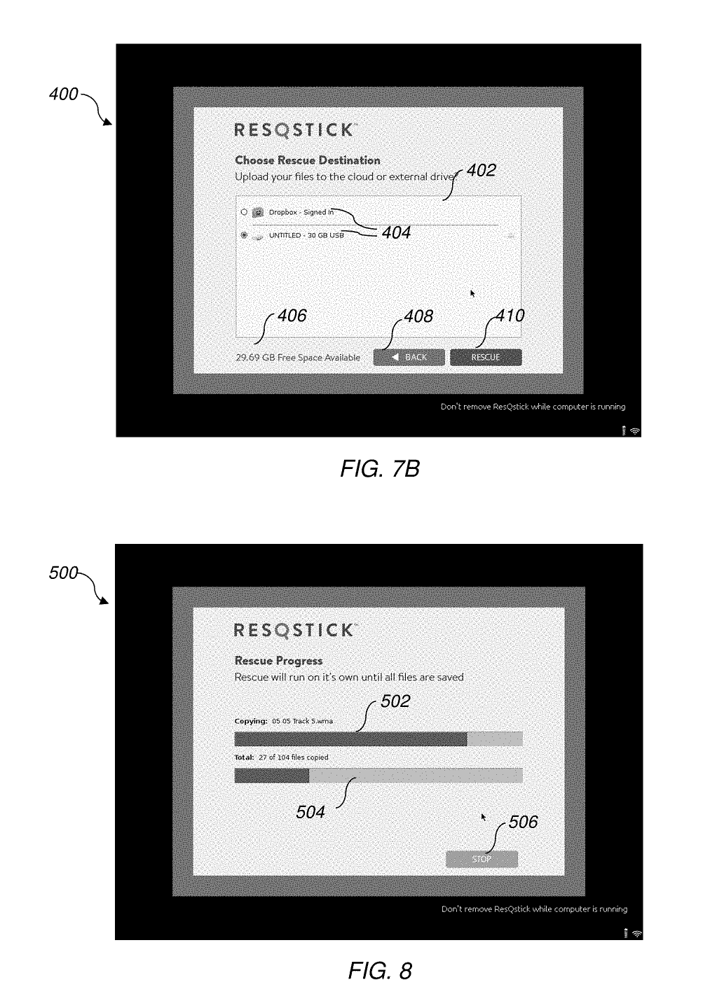

As illustrated by FIGS. 7A and 7B, a fourth page 400 of the wizard UI may enable a user to choose a destination for the files that are recovered from the hard drive 24 (FIG. 2). The options that are displayed by the fourth page 400 of the wizard UI may depend on a variety of factors, including, without limitation, the devices that are coupled to a communication port 22 (FIG. 2) of the computer 20 (FIG. 2) (e.g., the data recovery device 10 (FIGS. 1 and 2), another memory device, etc.) and whether or not the computer 20 is connected to the internet (e.g., cloud-based memory can be accessed, etc.). A list 402 of the available destinations 404 for files that are recovered from the hard drive 24 associated with the computer 20 may be displayed. In the illustrated example, the data recovery device 10 and a cloud-based memory option (DROPBOX™ file hosting service, GOOGLE DRIVE® file hosting service, AMAZON DRIVE® file hosting service, MICROSOFT ONEDRIVE® file hosting service, etc.) are shown on the fourth page 400 of the wizard UI as available destinations 404 for files that are recovered from the hard drive 24. The data recovery device 10 may be the preselected or default destination 404 for files that are recovered from the hard drive 24. As a user selects a destination 404 from the list 402 of available destinations 404, the fourth page 400 of the wizard UI may depict the amount of space available 406 at or on a selected destination 404.

The fourth page 400 of the wizard UI may also include a “Back” button 408 and a “Rescue” button 410.

In some embodiments, the data recovery program may only list cloud-based memory destination 404 options onto which the user is logged in using the computer 20. Alternatively, cloud-based memory destination 404 options may be identified by the user during registration or a subsequent setup of the data recovery device 10 and, upon selecting such an option and selecting the “Rescue” button 410 on the fourth page 400 of the wizard UI , the user may be required to login to the selected cloud-based memory destination 404 option.

When the “Rescue” button 410 of the fourth page 400 of the wizard UI is selected, the data recovery program may execute a data recovery process. In a specific, but non-limiting embodiment, the data recovery process may include one or more of the following functions:
For each individual file that has been selected, calling a corresponding destination plugin “copy” function to copy the file from the filesystem of the selected source to the filesystem of the selected destination;
For each folder that has been selected, calling a corresponding destination plugin “make directory” function to create a folder with the same name at the selected destination; and
Recursively, for each subfolder within a selected folder:
   If a subfolder was selected and was previously expanded, recursively copy all selected files; and/or
   If a subfolder was selected and was not previously expanded, start HDD filesystem subtree traverse routine: copy each file found to the selected destination, make a copy of each subfolder at the selected destination.

The fifth page 500 of the wizard UI, an embodiment of which is shown in FIG. 8, displays the progress of data recovery from the hard drive 24. When the fifth page 500 is active, the data recovery program may initiate the data recovery process by copying files selected using the third page 300 (FIG. 6) of the wizard UI to the destination 404 (FIGS. 7A and 7B) selected on the fourth page 400 (FIGS. 7A and 7B) of the wizard UI. The total recovery progress 504 of the data recovery process and/or a file recovery progress 502 for an individual file (as the individual file is recovered) may be shown.

In addition to displaying the progress of data recovery from the hard drive 24 (FIG. 2), the fifth page 500 may provide a “Stop” button 506, which may enable a user to terminate the data recovery process.

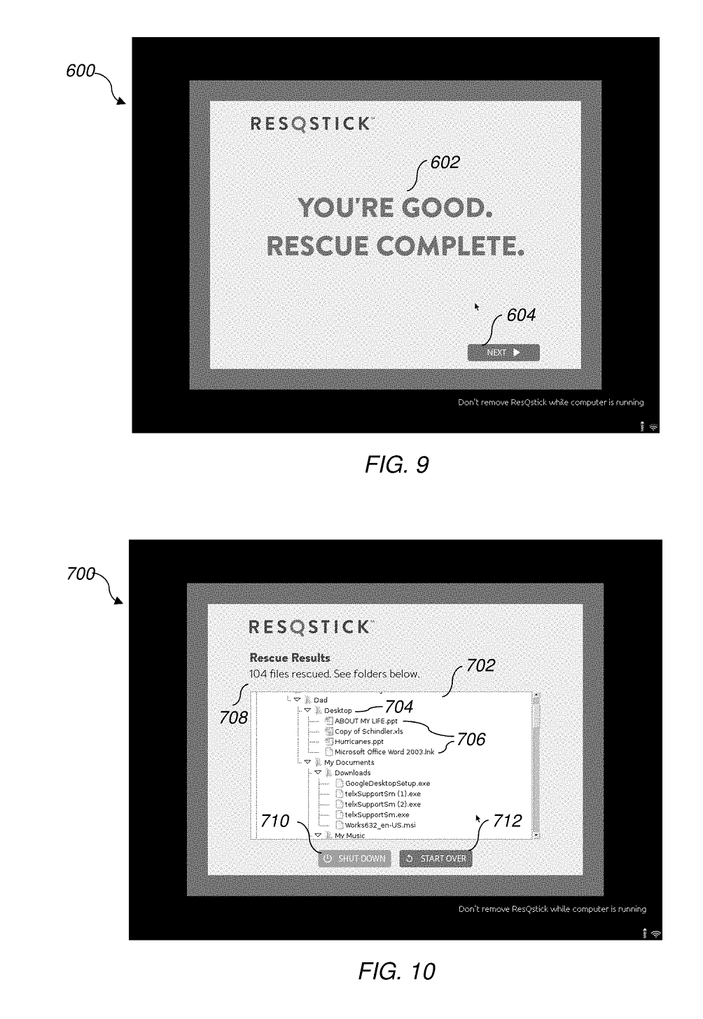

If the data recovery process ends without any errors, a sixth page 600 of the wizard UI may be displayed. An embodiment of such a sixth page 600 is depicted by FIG. 9. In that embodiment, the sixth page 600 of the wizard UI may display text 602 indicating that the data recovery process has been completed and was successful. The sixth page 600 of the wizard UI may also display a “Next” button 604.

When the “Next” button 604 displayed by the sixth page 600 of the wizard UI is selected, a seventh page 700 of the wizard UI may display a destination directory tree 702, such as that shown in FIG. 10. The seventh page 700 of the wizard UI may provide a file structure of the folders 704 and files 706 that have been recovered from the hard drive 24 (FIG. 2). In addition, the seventh page 700 of the wizard UI may display information 708 about the number and/or total size of the files that have been recovered.

The seventh page 700 of the wizard UI may also display a “Power Off” button 710, a “Start Over” button 712, and/or a menu button or an “Advanced” button (not shown). Selection of the “Power Off” button 710 may cause the computer 10 to shut down. Selection of the “Start Over” button 712 may restart the data recovery process. Selection of the “Advanced” button or an appropriate menu item on the first page of the wizard UI (FIG. 4) or on the seventh page of the wizard UI may cause the processor 21 of the computer 20 to display a main user interface, or “main UI.” Alternatively, a main UI may comprise the primary user interface of a data recovery program according to this disclosure.

A main UI may include at least three areas: a source directory tree (see, e.g., FIG. 6 and accompanying description); a panel; and a destination directory tree (see, e.g., FIG. 10 and accompanying description). The main UI may provide all of the functionality of the wizard UI in a single page and, in some embodiments, additional functionality, but without the requirement of a wizard UI.

The panel may include a “Find Your Files” button that may cause the data recovery program to identify each user profile available on the hard drive 24. Each available user profile may be listed on a popup dialog box, which may enable the user to select one or more user profiles from the listed user profiles (see, e.g., FIG. 5 and accompanying text). Once one or more user profiles have been selected, the popup dialog box that listed each available user profile may close and the folders that correspond to each selected user profile may be displayed by the source directory tree.

The source directory tree may enable a user to identify and select files that may be recovered from the hard drive, for example, in the manner described in reference to FIG. 6.

The destination directory tree may enable the user to identify one or more possible destinations for any files that may be recovered from the hard drive 24. The panel may enable the user to login to one or more cloud-based memory options. The panel may identify any memory devices that have been associated with the computer 20. The destination directory tree may also enable the user to expand a folder for each possible destination and see the contents of that folder and any of its subfolders. Such functionality may enable a user to select a particular destination for any files that are recovered from the hard drive 24. The main UI may also identify the selected destination and, optionally, the space available at the selected destination.

The panel may display a “Start Rescue” button than enables a user to initiate the data recovery process, for example, in accordance with the description that has been provided in reference to FIGS. 7A and 7B. In addition, the panel or a popup dialog box may provide a display of the progress of the data recovery process (see, e.g., FIG. 8). Such a display may show the total progress of the data recovery process and/or the progress of recovering each individual file that has been selected.

The panel of the main UI may also include a “Stop” button, which may enable a user to terminate the data recovery process.

An “Eject” button of the panel may enable a user to safely remove one or more selected memory devices from a communication port 22 of the computer 20. Upon “ejecting” a memory device, its information may be removed from the destination directory tree.

A “Settings” button of the panel may enable a user to select and/or edit settings for the data recovery device 10 and/or the data recovery program.

A “Power Off” button of the panel may facilitate a shutdown of the computer 20.

With returned reference to FIG. 2, a data recovery device 10 may also store an updater for a data recovery program according to this disclosure. The updater may be capable of causing the processor 21 of the computer 20 to whose communication port 22 the data recovery device 10 has been coupled to identify and implement updates to the data recovery program. Updates may be manual, for example, by selecting an update item from the menu 104 on a page (e.g., the first page 100 (FIG. 4) or the seventh page 700 (FIG. 10)) of a wizard UI of the data recovery program; by selecting an update button from the panel of a main UI of the data recovery program; or in any other suitable manner. Alternatively, updates may be automatic (e.g., by selecting an appropriate option while setting up the data recovery program and/or the data recovery device 10, etc.).

When prompted (manually or automatically) to check for an update, the updater may access a website associated with a provider of the data recovery program, determine whether a newer version of the data recovery program is available on that website. More specifically, the updater may parse a version file that contains the remote binary application version for the data recovery program, as well as a checksum (e.g., an MD5 checksum, etc.) for the remote binary application version.

If a newer version of the data recovery program is available on that website, i.e., the remote binary application version is newer than the current version of the data recovery program, the updater may download the remote binary file and save it in a temporary folder on the data recovery device 10. The download progress may be displayed in a dialog window output by the monitor 23 of the computer 20. The updater may cause the processor 21 of the computer 20 to compare the checksum of the downloaded remote binary application with a checksum associated with the version the data recovery program stored by the internal filesystem of the data recovery device 10. If the checksums do not match, the update process may be aborted. If the checksums do match, the remote binary file may be extracted from the downloaded file archive, decrypted (e.g., using a hardcoded encryption key, etc.), and saved to the internal filesystem (e.g., mounted to the “/suba” folder, etc.), from which the updated version of the data recovery program may then be accessed and executed, as described previously herein.

A data recovery device 10 may also store a program, which may be referred to as a “monitoring program,” that monitors the data recovery processes carried out by a data recovery program. The monitoring program may protect the data recovery program from software and/or hardware failures that may cause the processor 21 of the computer 20 to stop responding during execution of the data recovery processes of the data recovery program.

Such a monitoring program may comprise a monitoring application or a monitoring module. Loading scripts of the read-only filesystem of the data recovery device 10 may load and begin executing, or running, the application just after execution of the data recovery program begins. As execution of the monitoring application begins, it may open a so-called “pipe” type of file that may be shared with the data recovery program. Using the pipe type file, the monitoring application may start a timer, “listen for,” and detect so-called “ping” events from the data recovery program. If, at any time during execution of the data recovery program, the monitoring application does not detect a ping event for a predetermined timeout period of time, the monitoring application may cause the processor 21 of the computer 20 to cause the monitor 23 of the computer 20 to display a dialog box with a message indicating that the data recovery program is not responding and providing a user with one or more options; for example, an option to wait, an option to restart the data recovery program, and/or an option to restart the computer 20. If the user selects an option to wait, the dialog box may be removed from the monitor 23 and the monitoring application may restart its timer. If the option to restart the data monitoring program is selected, the dialog box may be removed from the monitor 23 and the monitoring application may terminate the data recovery program; the loading scripts of the read-only filesystem may determine that the data recovery process is no longer present and may relaunch the data recovery program.

Upon being loaded, a monitoring module may also open a so-called “pipe” type of file that may be shared with the data recovery program. Once the monitoring module loads, it may start a timer. The timer may send a ping event upon be started, and each time it is restarted. The timer may restart while the data recovery program runs. Thus, ping events are generated while the data recovery program continues to run. In the event that the data recovery program becomes experiences a fatal error or otherwise becomes stuck, the timer may reach a predetermined timeout period of time, during which no pings will be generated by the monitoring module. If that happens, the monitoring module may cause the processor 21 of the computer 20 to cause the monitor 23 of the computer 20 to display a message that execution of the data delivery program has failed and that the data recovery program or the computer 21 must be restarted.

Although the foregoing description contains many specifics, these should not be construed as limiting the scopes of the inventions recited by any of the appended claims, but merely as providing information pertinent to some specific embodiments that may fall within the scopes of the appended claims. Features from different embodiments may be employed in combination. In addition, other embodiments may also lie within the scopes of the appended claims. All additions to, deletions from and modifications of the disclosed subject matter that fall within the scopes of the claims are to be embraced by the claims.

What is claimed:

1. A device for recovering data from a hard drive of a computer, comprising:
a data storage device capable of being coupled to a communication port of the computer, the data storage device including memory, the memory including:
a portion that stores a data recovery program capable of:
automatically executing when the data storage device is coupled to the communication port of the computer with the computer turned on; and
upon automatically executing:
starting the computer;
mounting at least one hard drive associated with the computer;
identifying files stored on the at least one hard drive; and
enabling files from the at least one hard drive to be copied to a data storage device independent from the computer.

2. The device of claim 1, wherein the data recovery program is capable of starting a defective computer.

3. The device of claim 1, wherein the data recovery program is capable of bypassing security on the computer to start the computer, mount the at least one hard drive, identify files stored on the at least one hard drive, and enable files from the at least one hard drive to be copied to the data storage device independent from the computer.

4. The device of claim 1, wherein the data recovery program is capable of mounting at least one hard drive of a computer with a filesystem that cannot recognize the at least one hard drive.

5. The device of claim 1, wherein the data recovery program is capable of identifying files stored on at least one hard drive of a computer with a file system that does not enable communication with the at least one hard drive.

6. The device of claim 1, wherein the data recovery program is capable of mounting the at least one hard drive, identifying files stored on the at least one hard drive, and enabling files on the at least one hard drive to be copied to the data storage device without altering the at least one hard drive.

7. The device of claim 1, wherein the data recovery program is capable of wiping all data from the at least one hard drive.

8. The device of claim 7, wherein the data recovery program is also capable of:
generating a label for mailing the at least one hard drive or the computer to a recycling facility; and/or
generating a certification that the at least one hard drive and/or the computer complies with governmental requirements for transportation and/or recycling.

9. The device of claim 1, wherein the data storage device further includes:
another portion capable of receiving copies of the files from the hard drive.

10. The device of claim 1, wherein the program is capable of:
enabling files from the at least one hard drive to be copied to a data storage device remote from the computer.

11. The device of claim 1, wherein the program is capable of:
enabling files from the at least one hard drive to be copied to another external data storage device that has been coupled to the computer.

12. A device for recovering data from a hard drive of a computer, comprising:
a data storage device capable of being coupled to a communication port of the computer, the data storage device including memory, the memory including:
a portion that stores an operating system for starting the computer;
another portion that stores a data recovery program capable of:
automatically executing when the data storage device is coupled to the communication port of the computer with the computer turned on; and
upon automatically executing:
causing the operating system to start the computer;
causing the operating system to mount at least one hard drive associated with the computer;
identifying files stored on the at least one hard drive; and
enabling files from the at least one hard drive to be copied to a data storage device independent from the computer.

13. A method for recovering files from a computer, comprising:
coupling a data storage device storing a recovery program to a communication port of the computer;
automatically executing the recovery program as soon as the data storage device is coupled to the communication port of the computer and the computer is turned on;
booting a processor of the computer with the recovery program;
mounting at least one hard drive coupled to the computer;
identifying files stored on the at least one hard drive; and
enabling files from the at least one hard drive to be copied to a data storage device independent from the computer.

14. The method of claim 13, further comprising:
bypassing security of the computer.

15. The method of claim 13, wherein booting comprises booting the processor of a defective computer.

16. The method of claim 13, wherein mounting, identifying, and enabling occur without altering data on the at least one hard drive.

17. The method of claim 13, further comprising:
providing a user with an option to wipe the at least one hard drive.

18. The method of claim 17, further comprising:
generating a label for mailing the at least one hard drive or the computer to a recycling facility; and/or
generating a certification that the at least one hard drive and/or the computer complies with governmental requirements for transportation and/or recycling.

19. The method of claim 13, further comprising:
transferring files from the at least one hard drive to the data storage device independent from the computer.

20. The method of claim 19, wherein transferring the files comprises transferring the files to the data storage device storing the recovery program.
